(19) United States
(12) Patent Application Publication
(10) Pub. No.: US 2023/0037314 A1
(43) Pub. Date: Feb. 9, 2023

(54) Moulding composition comprising polyether block amide

(71) Applicant: Evonik Operations GmbH, Essen (DE)

(72) Inventors: Chenyu Ye, Shanghai (CN); Kathrin Salwiczek, Recklinghausen (DE); Urs Welz-Biermann, Lafayette, IN (US); Klaus Hülsmann, Haltern Am See (DE); Peter Hannen, Herten (DE); He Zhang, Shanghai (CN)

(73) Assignee: Evonik Operations GmbH, Essen (DE)

(21) Appl. No.: 17/757,440

(22) PCT Filed: Dec. 19, 2019
(86) PCT No.: PCT/CN2019/126548

§ 371 Date: Jun. 15, 2022

(51) Int. Cl. C08L 77/06

(52) U.S. Cl. CPC C08L 77/06

(57) ABSTRACT

A moulding composition contains a) 75 wt. % to 98.5 wt. % of a polyether block amide, based on a total weight of the moulding composition. The polyether block amide contains a subunit 1, composed of at least one lactam or α,ω-aminocarboxylic acid having 6 to 14 carbon atoms, and a subunit 2, composed of at least one amino- or hydroxy-terminated polyether having at least two carbon atoms per ether oxygen and at least two primary amino or at least two hydroxy groups at the chain ends. The moulding composition also contains b) 1.5 wt. % to 25 wt. % of at least one polyalkenamer, based on a total weight of the moulding composition. The at least one polyalkenamer contains at least one cycloalkene having 5 to 12 carbon atoms. A moulded article can be produced from the moulding composition, which can be a moulding, a film, a bristle, a fibre or a foam.

### FIELD OF THE DISCLOSURE

The present disclosure relates to a moulding composition comprising polyether block amide (PEBA), to a moulded article produced therefrom and to the use thereof.

### BACKGROUND

Polyether block amides (PEBA) are block copolymers which are obtained by polycondensation of (oligo)polyamides, in particular acid-regulated polyamides, with alcohol-terminated or amino-terminated polyethers. Acid-regulated polyamides have carboxylic acid end groups in excess. Those skilled in the art refer to the polyamide blocks as hard blocks and the polyether blocks as soft blocks. The production thereof is known in principle. DE2712987A1 (U.S. Pat. No. 4,207,410) describes polyamide elastomers of this type, composed of lactams containing 10-12 carbon atoms, dicarboxylic acids and polyether diols. The products obtainable according to this document are distinguished by long-lasting flexibility and ductility even at low temperatures, but they are already cloudy to opaque in mouldings of moderate layer thickness and, on longer-term storage at room temperature, are conspicuous due to surface blooming having a mildew-like appearance.

Blooming may impact surface aesthetics and therefore should be reduced to keep a visual appealing of the moulded articles, especially for consumer products with specific design approaches such as sport shoes or sport equipment.

### SUMMARY

To this end, it was an object of the disclosure to provide suitable moulding compositions, which are associated with good mechanical properties and freedom from blooming even over a relatively long period of time.

This object was achieved with a moulding composition comprising, based on a total weight of the moulding composition: a) 75 wt. % to 98.5 wt. % of a polyether block amide based on the moulding composition, comprising a subunit 1, composed of at least one lactam or α,ω-aminocarboxylic acid having 6 to 14 carbon atoms, and on a subunit 2, composed of at least one amino- or hydroxy-terminated polyether having at least two carbon atoms per ether oxygen and at least two primary amino or at least two hydroxy groups at the chain ends, and b) 1.5 wt. % to 25 wt. % of at least one polyalkenamer based on the moulding composition, comprising at least one cycloalkene having 5 to 12 carbon atoms. It is preferred that the at least two primary amino or at least two hydroxy groups at the chain ends of the polyether are in α,ω-position.

In one preferred embodiment, the polyalkenamer is selected from the group of polypentenamer, polyheptenamer, polynorbomene, polyoctenamer, polydecenamer, polydicyclo-pentadiene, polydodecenamer and mixtures thereof; polyoctenamer is a preferred polyalkenamer.

In one preferred embodiment, the weight percentage of the polyalkenamer in the moulding composition is 2 wt. % to 12%, based on the total weight of the moulding composition.

In one preferred embodiment, the weight percentage of the polyalkenamer in the moulding composition is 2.5 wt. % to 11%, based on the total weight of the moulding composition.

In one preferred embodiment, the subunit 1 constitutes a content of 45 wt. % to 90 wt. %, preferably 50 wt. % to 85 wt. %, based on a total weight of the polyether block amide.

In one preferred embodiment, the subunit 2 constitutes a content of 10 wt. % to 40 wt. %, preferably 15 wt. % to 35 wt. %, based on a total weight of the polyether block amide.

In one preferred embodiment, the α,ω-aminocarboxylic acid is selected from among 6-aminohexanoic acid, 9-aminononanoic acid, 10-aminodecanoic acid, 11-aminoundecanoic acid, 12-aminododecanoic acid, N-heptyl-11-aminoundecanoic acid, and mixture thereof.

In one preferred embodiment, the lactam is selected from among pyrrolidinone, piperidinone, caprolactam, enantholactam, caprylolactam, pelargolactam, decanolactam, undecanolactam, laurolactam, and mixture thereof, more preferably caprolactam, laurolactam, and mixture thereof.

In one preferred embodiment, the amino- or hydroxy-terminated polyether is selected from polyethylene glycol, polypropylene glycol, polytetramethylene glycol, amino-terminated polyethylene glycols, amino-terminated polypropylene glycols, amino-terminated polytetramethylene glycols, and mixtures thereof.

The disclosure further provides a moulded article produced from the moulding composition according to the disclosure. The moulded article is preferably a moulding, a film, a bristle, a fibre or a foam. The moulded article may for example be produced by compression-moulding, foaming, extrusion, coextrusion, blow moulding, 3D blow moulding, coextrusion blow moulding, coextrusion 3D blow moulding, coextrusion suction blow moulding or injection moulding. Processes of this kind are known to those skilled in the art.

The disclosure further provides the use of the moulded article according to the disclosure, which may for example be used as a fibre composite component, shoe sole, top sheets for skis or snowboards, line for media, spectacle frame, design article, sealing material, body protection, insulating material or housing part provided with a film.

### DETAILED DESCRIPTION

The following description is used merely for illustration but is not to restrict the scope of the disclosure.

The term, “polymer” refers to, but is not limited to, oligomers, homopolymers, copolymers, terpolymers, and the like. The polymers may have various structures including, but not limited to, regular, irregular, alternating, periodic, random, block, graft, linear, branched, isotactic, syndiotactic, atactic, and the like.

### [PEBA]

PEBA used herein is preferably based on a subunit 1, composed of at least one lactam or α,ω-aminocarboxylic acid having 6 to 14 carbon atoms, and on a subunit 2, composed of at least one amino- or hydroxy-terminated polyether having at least 2 carbon atoms per ether oxygen.

PEBA are known in the art and result from the polycondensation of polyamide blocks with reactive ends (like oligoamiddicarboxylic acids) with polyether blocks with reactive ends. It is preferred to obtain PEBA from polyamide blocks with dicarboxylic chain ends. Subunit 1 may result from the condensation of one or more α,ω-aminocarboxylic acids or of one or more lactams in the presence of a dicarboxylic acid, preferably a linear aliphatic dicarboxylic acid. The dicarboxylic acid may contain from 4 to 36 carbon atoms, preferably from 6 to 12 carbon atoms. As examples of dicarboxylic acids mention may be made of 1,4-cyclohexyidlcarboxyllc acid, butanedioic, adipic, azelaic, suberic, sebacic, dodecanedicarboxylic, octadecanedicarboxylic and terephthalic and isophthalic acids, but also dimerized fatty acids. PEBA and methods for their production are described in US 2006/0189784, for example.

PEBA for the moulding composition could be used as prepared or available from the market. Commercially, PEBAs with different subunit 1 as polyamide part or subunit 2 as polyether part could be purchased from, for example, Evonik Resource Efficiency GmbH and Arkema S. A.

### Lactam and α,ω-Aminocarboxylic Acid

In PEBA, the subunit 1 is composed of at least one lactam or α,ω-aminocarboxylic acid having 6 to 14 carbon atoms. More preferably, the lactam or α,ω-aminocarboxylic acid has 8 to 14 carbon atoms. Still more preferably, the lactam or α,ω-aminocarboxylic acid has 10 to 14 carbon atoms.

Preferably, the polyamide may be a homopolymer of one lactam or one amino-acid. However, it is still possible to prepare a polyamide through copolymerization of two or more lactams or amino-acids having different number of carbon atoms.

Preferably, the α,ω-aminocarboxylic acid is selected from among 6-aminohexanoic acid, 9-aminononanoic acid, 10-aminodecanoic acid, 12-aminododecanoic acid, 11-aminoundecanoic acid, N-heptyl-11-aminoundecanoic acid, and mixture thereof.

Preferably, the lactam is selected from among pyrrolidinone, piperidinone, caprolactam, enantholactam, caprylolactam, pelargolactam, decanolactam, undecanolactam, laurolactam, and mixture thereof, more preferably caprolactam, laurolactam, and mixture thereof. Laurolactam is most preferred.

In PEBA, the subunit 1 including constitutes a content of preferably 80 wt. % to 90 wt. %, more preferably 65 wt. % to 85 wt. %, based on the total weight of PEBA.

The number-average molecular weight of subunit 1 is preferably 200 to 1500 g/mol.

### Amino- or Hydroxy-Terminated Polyether

The amino- or hydroxy-terminated polyether used in synthesis of PEBA contain at least two primary amino or at least two hydroxy groups at both ends of the molecular chain and a backbone made of ether (C—O—C) connectivity. The amino- or hydroxy-terminated polyether of the PEBA is preferably selected from polyethylene glycol, polypropylene glycol, polytetramethylene glycol (polytetrahydrofuran, PTHF), amino-terminated polyethylene glycols, amino-terminated polypropylene glycols, amino-terminated polytetramethylene glycols, and mixtures thereof. The number-average molecular weight of the amino- or hydroxy-terminated polyether is preferably 800-2500.

The subunit 2 constitutes a content of preferably 10 wt. % to 40 wt. %, more preferably 15 wt. % to 35 wt. %, based on the total weight of PEBA.

### [Polyalkenamer]

Polyalkenamers are usually produced by a ring-opening metathesis polymerization of cycloalkenes (cyclic olefins) with the presence of catalysts. The polyalkenamers may contain a fraction of macrocycle polymers, besides the linear polymers. Preferably, the cycloalkenes have an average number of carbon atom of 5 to 12 per carbon ring. Preferred examples of polymers include polypentenamer, polyheptenamer, polynorbomene, polyoctenamer, polydecenamer, polydicyclopentadiene, and polydodecenamer whereby polyoctenamer is preferred. The polyoctenamer especially comprises trans-polyoctenamer. Those polyalkenamers are also commercially available in the brand names of, for example, Vestenamer® 8012 from Evonik Resource Efficiency GmbH, or Norsorex® from Astrotech Advanced Elastomerproducts GmbH.

The content of polyalkenamers within the moulding composition is preferably 1.5 wt. % to 25 wt. %, more preferably 2 wt. % to 12 wt. %, even more preferably 2.5 wt. % to 11 wt. %, based on the total weight of the moulding composition. When the content of polyalkenamers is too high, e.g., more than 25 wt. %, an incompatibility of the polyalkenamers in the molding composition may occur. In addition, in case the amount of polyalkenamers is above 12 wt.-% the moulding composition may demonstrate weak cold notched impacted resistance and therefore it may fail to meet some requirements of certain applications. When the content of polyalkenamers is too low, e.g., less than 1.5 wt. %, the blooming may not be controlled efficiently.

### [Additives]

The moulding composition according to the disclosure may comprise as constituents, in addition to the components according to a) and b), further additives preferably selected from light stabilizers, heat stabilizers, flame retardants, plasticizers, filers, nanoparticles, antistats, dyes, pigments, mould-release agents or flow assistants, with an total amount not greater than 10 wt. %, preferably not greater than 5 wt. % based on the total weight of the moulding composition.

Preferably, the moulding composition according to the disclosure consists of the above specified constituents.

The disclosure is illustrated by way of example and comparative examples hereinbelow.

### Examples

Vestenamer® 8012 available from Evonik Resource Efficiency GmbH is a semicrystalline trans-polyoctenamer as the major composition and a high proportion of macrocycle polymers.

Vestamid® E55-S3 from Evonik Resource Efficiency GmbH is a low density, polyether block amide (PEBA) block polymer, containing segments of PA 12 and polyether. Vestamid® E55-S3 has a Shore D hardness of 55.

Vestamid® E58-S4 from Evonik Resource Efficiency GmbH is a low density, polyether block amide (PEBA) block polymer, containing segments of PA 12 and polyether. Vestamid® E58-S4 has a Shore D hardness of 58.

Vestamid® E62-S3 from Evonik Resource Efficiency GmbH is a low density, polyether block amide (PEBA) block polymer, containing segments of PA 12 and polyether. Vestamid® E62-S3 has a Shore D hardness of 62.

All the three PEBAs are heat and light (UV) stabilized and transparent.

### [Testing of the Moulding Composition]

Melt mixtures were produced on a Coperion ZSK-26mc co-rotating twin screw extruder, discharged, pelletized to obtain the moulding compositions according to the recipe indicated in Table 1, wherein the Vestamid® E series PEBAs and Vestenamer® 8012 were dry blended and fed into the main port of extruder and then mixed at a range of 190 to 250° C.

The polymer compositions in pellet form were processed on an injection moulding machine Engel VC 650/200 (melt temperature 220° C.; mould temperature 35° C.) to prepare specimens for mechanical performance tests.

Tensile modulus of elasticity, tensile stress at yield, tensile stress at break and elongation at break were determined by Zwick Z020 materials testing system according to ISO 527, on ISO tensile specimens, type 1A, 170 mm×10 mm×4 mm at a temperature (23±2) ° C., relative humidity (50±10) %.

Notched Impact strength under cold condition was determined by CEAST Resil Impactor 6967.000, according to ISO 179/1 eA (Charpy) on tensile specimens ISO 527 type 1A which were cut off two ends, 80 mm×10 mm×4 mm at temperature (−30±2) ° C., relative humidly (50±10) %.

Hardness (shore D) was determined by Time group shore D hardness tester TH210, according to ISO 868, on tensile specimens ISO 527 type 1A 170 mm×10 mm×4 mm at a temperature (23±2) ° C., relative humidity (50±10) %.

Injection-moulded plaques measuring 1-2-3 three-stage plates were produced from the molding compositions as test specimens. The three-stage plate has a width of 55 mm. Each stage has a length of 30 mm. For the first, second, and third stages, the thickness is 1 mm, 2 mm, and 3 mm, respectively.

Blooming was ascertained after the three-stage plates had been stored for a test period of 7 days in a closed vessel with water vapour with a 95% humidity at 70° C. Blooming level was assessed visually using a four-point scale (from I to IV, where I=free of blooming, and IV=subject to heavy blooming).

The overall results are shown in Table 1.

TABLE 1
Moulding compositions

| | | | | | | | | | | | |
|---|---|---|---|---|---|---|---|---|---|---|---|
| CE1 | E1 | E2 | E3 | E4 | E5 | E6 | E7 | CE2 | E8 | CE3 | E9 |

Recipe

| | | | | | | | | | | | | |
|---|---|---|---|---|---|---|---|---|---|---|---|---|
| Vestamid ® E55-S3 (wt. %) | 100 | 99.5 | 99 | 97 | 95 | 90 | 85 | 80 | — | — | — | — |
| Vestamid ® E58-S4 (wt. %) | — | — | — | — | — | — | — | — | — | — | 100 | 95 |
| Vestamid ® E62-S3 (wt. %) | — | — | — | — | — | — | — | — | 100 | 95 | — | — |
| Vestenamer ® 8012 (wt. %) | — | 0.5 | 1 | 3 | 5 | 10 | 15 | 20 | — | 5 | — | 5 |

Property

| | | | | | | | | | | | | |
|---|---|---|---|---|---|---|---|---|---|---|---|---|
| Shore D hardness | 55 | 55 | 55 | 54 | 53 | 53 | 51 | 50 | 62 | 60 | 58 | 57 |
| Blooming level | II | II | II | I | I | I | I | I | III | I | II | I |
| Tensile modulus (MPa) | 220 | 241 | 241 | 230 | 213 | 203 | 205 | 202 | 370 | 380 | 185 | 201 |
| Tensile strength (MPa) | 38 | 36 | 38 | 37 | 39 | 44 | 42 | 37 | 42 | 43 | 39 | 36 |
| Elongation @ break (%) | >200 | >200 | >200 | >200 | >200 | >200 | >200 | >200 | >200 | >200 | >200 | >200 |
| Notched impact −30° C. | 22 | 38 | 37 | 44 | 41 | 40 | 17 | 17 | 8 | 10 | 5 | 6.8 |
| (kJ/m²) | | | | | | | | | | | | |

By the test data of inventive examples (E1 through E9) and comparative examples (CE1 through CE3), it is shown that with introduction of Vestenamer® 8012, blooming level of the specimen is reduced significantly. At the same time, Shore D hardness, tensile modulus, and tensile strength are maintained, indicated by neglible changes of experiment values. Under −30° C. environment, the notched impact resistance of the inventive specimen is very high. However, the resistance decreases at higher concentrations (ca. 15 wt. %) of Vestenamer® 8012.

1: A moulding composition, comprising:
75 wt. % to 98.5 wt. % of a polyether block amide, comprising
a subunit 1, composed of at least one lactam or α,ω-aminocarboxylic acid having 6 to 14 carbon atoms, and
a subunit 2, composed of at least one amino- or hydroxy-terminated polyether having at least two carbon atoms per ether oxygen and at least two primary amino groups or having at least two carbon atoms per ether oxygen and at least two hydroxy groups at the chain ends, and
1.5 wt. % to 25 wt. % of at least one polyalkenamer, comprising at least one cycloalkene having 5 to 12 carbon atoms;
based on a total weight of the moulding composition.

2: The moulding composition according to claim 1, wherein the at least one polyalkenamer is selected from the group consisting of polypentenamer, polyheptenamer, polynorbomene, polyoctenamer, polydecenamer, polydicyclo-pentadiene, polydodecenamer, and a mixture thereof.

3: The moulding composition according to claim 2, wherein the at least one polyalkenamer comprises a polyoctenamer.

4: The moulding composition according to claim 1, wherein the moulding composition comprises 2 to 12 wt. % of the at least one polyalkenamer, based on the total weight of the moulding composition.

5: The moulding composition according to claim 4, wherein the moulding composition comprises 2.5 wt. % to 11 wt. % of the at least one polyalkenamer, based on the total weight of the moulding composition.

6: The moulding composition according to claim 1, wherein the polyether block amide comprises the subunit 1 in a content of 45 wt. % to 90 wt. %, based on a total weight of the polyether block amide.

7: The moulding composition according to claim 1, wherein the polyether block amide comprises the subunit 2 in a content of 10 wt. % to 40 wt. %, based on a total weight of the polyether block amide.

8: The moulding composition according to claim 1, wherein the α,ω-aminocarboxylic acid is selected from the group consisting of 6-aminohexanoic acid, 9-aminononanoic acid, 10-aminodecanoic acid, 11-aminoundecanoic acid, 12-aminododecanoic acid, N-heptyl-11-aminoundecanoic acid, and a mixture thereof.

9: The moulding composition according to claim 1, wherein the at least one lactam is selected from the group consisting of pyrrolidinone, piperidinone, caprolactam, enantholactam, caprylolactam, pelargolactam, decanolactam, undecanolactam, laurolactam, and a mixture thereof.

10: The moulding composition according to claim 9, wherein the at least one lactam is selected from the group consisting of caprolactam, laurolactam, and a mixture thereof.

11: The moulding composition according to claim 1, wherein the at least one amino- or hydroxy-terminated polyether is selected from the group consisting of polyethylene glycol, polypropylene glycol, polytetramethylene glycol, an amino-terminated polyethylene glycol, an amino-terminated polypropylene glycol, an amino-terminated polytetramethylene glycol, and a mixture thereof.

12: A moulded article produced from the moulding composition according to claim 1.

13: The moulded article according to claim 12, wherein said article is a board, a film, a bristle, a fibre, or a foam.

14: The moulded article according to claim 12, wherein the moulded article is produced by compression-moulding, foaming, extrusion, coextrusion, blow moulding, 3D blow moulding, coextrusion blow moulding, coextrusion 3D blow moulding, coextrusion suction blow moulding, or injection moulding.

15: The moulded article according to claim 12, wherein the moulded article is a fibre composite component, a shoe sole, a top sheet for skis or snowboards, a line for media, a spectacle frame, a design article, a sealing material, a body protection, an insulating material, or a housing part provided with a film.

16: The moulding composition according to claim 6, wherein the polyether block amide comprises the subunit 1 in an amount of 50 wt. % to 85 wt. %, based on the total weight of the polyether block amide.

17: The moulding composition according to claim 7, wherein the polyether block amide comprises the subunit 2 in an amount of 15 wt. % to 35 wt. %, based on the total weight of the polyether block amide.
